(19) United States
(12) Patent Application Publication
(10) Pub. No.: US 2020/0322639 A1
(43) Pub. Date: Oct. 8, 2020

(54) SYNTAX-BASED METHOD OF DETECTING OBJECT INTRUSION IN COMPRESSED VIDEO

(71) Applicant: INNODEP CO., LTD., Seoul (KR)

(72) Inventors: Hyun Woo LEE, Seoul (KR); Seung Hoon JUNG, Seoul (KR); Hyun Seong BAE, Seoul (KR); Sung Jin LEE, Gwangmyeong-si, Gyeonggi-do (KR)

(21) Appl. No.: 16/305,849

(22) PCT Filed: Mar. 4, 2018
(86) PCT No.: PCT/KR2018/002557

§ 371 Date: Nov. 29, 2018

(30) Foreign Application Priority Data
Dec. 20, 2017 (KR) 10-2017-0176600

(51) Int. Cl. H04N 19/70; H04N 19/20; H04N 19/105; H04N 19/159; H04N 19/132; H04N 19/176

(52) U.S. Cl. CPC H04N 19/70; H04N 19/20; H04N 19/176; H04N 19/159; H04N 19/132; H04N 19/105

(57) ABSTRACT

The present invention relates to a technology of detecting object intrusion event in compressed video, e.g., CCTV cameras generating, by extracting regions of moving object, i.e., regions in which substantial movement exists, in the compressed video based on syntax information, such as motion vector and coding type, of each of image blocks of the compressed video without performing conventional complicated image processing, and then persistently finding the regions of moving object in a predetermined region-of-interest more than a time-threshold. The present invention may provide an advantage that crime prevention effect of video surveillance system may be enhanced because an intrusion into a region-of-interest may be detected in real-time manner out of CCTV video without performing complicated processing, i.e., decoding, downscale resizing, differential obtaining, and image analysis, etc.

### FIELD OF THE INVENTION

The present invention generally relates to a technology of effectively detecting object intrusion in compressed video, e.g., H.264 AVC, H.265 HEVC, etc.

More specifically, the present invention relates to a technology of detecting object intrusion event in compressed video, e.g., CCTV cameras generating, by extracting regions of moving object, i.e., regions in which substantial movement exists, in the compressed video based on syntax information, such as motion vector and coding type, of each of image blocks of the compressed video without performing conventional complicated image processing, and then finding the regions of moving object being persistently present in a predetermined region-of-interest more than a time-threshold.

### BACKGROUND ART

Recently, in order to provide crime prevention or proof of criminal evidence, CCTV-based video surveillance systems are widely built. Installing CCTV cameras for each section of area, videos captured by the CCTV cameras are displayed on monitor screens and recorded in storage devices. If monitoring agents finds a scene of crime or accident, he or she may immediately take action in a proper way, or may search video in the storage devices for evidence if necessary.

However, the number of monitoring agents is very insufficient compared to the number of CCTV cameras. In order to effectively accomplish video surveillance with this limited number of personnel, it is inappropriate to simply display CCTV video on monitor screen. Rather, it is preferable to detect movement of object in each CCTV video and then further display something on its corresponding region in real-time manner so as to make the movement of object be easily found. In this case, the monitoring agents may focus on regions where movement of object is detected in CCTV video, rather than uniformly monitoring the overall CCTV video.

By the way, compressed video is being adopted in video surveillance system for the efficiency of storage space. In special, as the number of CCTV cameras rapidly grows and high-definition cameras are usually installed, complicated video compression technologies of higher compression such as H.264 AVC or H.265 HEVC, etc. are being adopted.

The camera devices shall produce and provide video data in a form of compressed video by any one of the technical standards as above. Then, video replay devices shall receive the compressed video and then perform decoding by the technical standard which has been used in encoding the compressed video. Conventionally, in order to check the presence of movement in compressed CCTV video, the compressed video shall be decoded so as to obtain reproduced video, i.e., the original video data which has been decompressed and then to be image processed.

FIG. 1 is a block diagram illustrating the general constitution of a video decoding apparatus according to H.264 AVC technical specification. Referring to FIG. 1, the video decoding apparatus of H.264 AVC may comprise syntactic analyzer 11, Entropy decoder 12, inverse transformer 13, motion vector calculator 14, predictor 15, and deblocking filter 16.

These hardware modules process the compressed video in sequence so as to perform decompression and recover original image data. The syntactic analyzer 11 parses the compressed video so as to obtain motion vector and coding type for each of coding unit. The coding units are generally image blocks such as macro blocks or sub blocks, which may be implemented differently according to technical specifications.

FIG. 2 is a flow chart illustrating a procedure of detecting object intrusion in compressed video in conventional video analysis solutions.

Referring to FIG. 2, the compressed video shall be decoded by H.264 AVC or H.265 HEVC, etc. (S10), and then image frames of reproduced images shall be downscale resized into smaller images, e.g., 320×240 (S20). The downscale resizing is performed in order to reduce computing load in following steps. Then, differential images shall be obtained out of the resized frame images, and then moving objects shall be extracted by image analysis (S30). Then, routes of the extracted moving objects shall be obtained by video analysis so as to detect someone's intrusion into a specific ROI (Region-Of-Interest) (e.g., factory, warehouse, dormitory and house) (S40).

In conventional solutions, decoding of compressed video and downscale resizing, and image analysis shall be processed in order to extract moving objects. These are very complicated processing, which limits the capacity of video analysis server in conventional video surveillance systems. Currently, the maximum number of CCTV channels which a high-performance video analysis server can deal with is sixteen (16) in general. Because pluralities of CCTV cameras are being installed, video surveillance system requires pluralities of video analysis servers, which causes problems such as increased cost and difficulty in physical space.

Because building and maintaining a large-scale video surveillance system requires significant budget, the system shall provide valuable utilities, which includes crime prevention and proof of criminal evidence. Accordingly, rather than simply recording video of surroundings or informing presence of moving objects therefrom, it is necessary that video surveillance system may provide higher level of detection function so as to detect by software any special situation which itself is problematic in the experience in our real life. Further, efficient implementation technology is also required in view of realistic problems such as system build cost and physical space.

### DISCLOSURE OF INVENTION

### Technical Problem

In general, it is an object of the present invention to provide a technology of effectively detecting object intrusion in compressed video, e.g., H.264 AVC, H.265 HEVC, etc.

More specifically, it is another object of the present invention to provide a technology of detecting object intrusion event in compressed video, e.g., CCTV cameras generating, by extracting regions of moving object, i.e., regions in which substantial movement exists, in the compressed video based on syntax information, such as motion vector and coding type, of each of image blocks of the compressed video without performing conventional complicated image processing, and then finding the regions of moving object being persistently present in a predetermined region-of-interest more than a time-threshold.

### Technical Solution

In order to achieve the object as above, the syntax-based method of detecting object intrusion in compressed video according to the present invention comprises: a first step of parsing bit-stream of the compressed video so as to obtain motion vector and coding type for coding unit; a second step of obtaining motion vector accumulation for a predetermined first time-period for a plurality of image blocks which constituting the compressed video; a third step of comparing the motion vector accumulation to a predetermined first threshold for the plurality of image blocks; a fourth step of marking as region of moving object some of the image blocks which having the motion vector accumulation higher than the first threshold; and a fifth step of providing object intrusion event for the region of moving object when finding the region of moving object being persistently present for a predetermined second time-period in a predetermined ROI (region-of-interest) in the compressed video.

In the present invention, the image blocks which constituting the compressed video may comprise macro blocks and sub blocks.

Further, the fifth step may comprise: a step 5a of newly issuing a Unique ID so as to allocate the Unique ID to the region of moving object which being of ID-unallocated state; a step 5b of identifying entry of the region of moving object into a predetermined ROI in the compressed video; a step 5c of providing object intrusion event for the region of moving object which being persistently present with the same Unique ID in a sequence of image frames corresponding to a predetermined second time-period in the compressed video; and a step 5d of revoking the allocated Unique ID from the region of moving object which disappearing from the series of image frames.

Further, the method of detecting object intrusion according to the present invention may further comprise: a step a of identifying a plurality of image blocks (hereinafter referred to as ‘neighboring blocks’) which being located adjacent around the region of moving object; a step b of comparing motion vectors of the plurality of neighboring blocks and a predetermined second threshold; a step c of further marking as region of moving object some of the neighboring blocks which having motion vector higher than the second threshold; a step d of further marking as region of moving object some of the neighboring blocks whose coding type being Intra Picture; and a step e of performing interpolation to the plurality of regions of moving object so as to further mark as region of moving object unmarked image blocks which being surrounded by region of moving objects, wherein the number of unmarked image blocks is less than a predetermined number.

Further, the non-transitory computer-readable medium according to the present invention contains in a computer device a program code which executes the syntax-based method of detecting object intrusion in compressed video as above.

### Advantageous Effects

The present invention may provide an advantage that about 20 times better performance than conventional video analysis servers may be obtained because regions of moving object may be extracted out of CCTV compressed video without performing complicated processing, i.e., decoding, downscale resizing, obtaining of differential, and image analysis, etc.

Further, the present invention may provide an advantage that crime prevention effect of video surveillance system may be enhanced because an intrusion into a region-of-interest may be detected in real-time manner out of CCTV video without performing complicated processing, i.e., decoding, downscale resizing, obtaining of differential, and image analysis, etc.

### BRIEF DESCRIPTION OF THE DRAWINGS

FIG. 1 is a block diagram illustrating the general constitution of a video decoding apparatus.

FIG. 2 is a flow chart illustrating a conventional procedure of detecting object intrusion in compressed video.

FIG. 3 is a flow chart illustrating an overall procedure of detecting object intrusion in compressed video according to the present invention.

FIG. 4 is a flow chart illustrating an embodiment of the procedure of detecting effective movement in compressed video in the present invention.

FIG. 5 is a view illustrating an example of the result of performing the procedure of detecting region of effective movement on a CCTV monitoring screen according to the present invention.

FIGS. 6 and 7 are partial enlargement views of important parts in FIG. 5.

FIG. 8 is a flow chart illustrating an embodiment of the procedure of detecting boundary area of region of moving object in the present invention.

FIG. 9 is a view illustrating an example of the result of performing the procedure of detecting boundary area of region of moving object according to the present invention.

FIGS. 10 and 11 are partial enlargement views of important parts in FIG. 9.

FIG. 12 is a view illustrating an example of the result of performing interpolation so as to make up regions of moving object in the present invention.

FIGS. 13 and 14 are partial enlargement views of important parts in FIG. 12.

FIG. 15 is a flow chart illustrating an embodiment of the procedure of detecting object intrusion event based on persistency of existence of the region of moving object in region-of-interest in the present invention.

FIG. 16 shows an example of allocating Unique ID's to regions of moving objects in the present invention.

### EMBODIMENT FOR CARRYING OUT THE INVENTION

The present invention shall be described in detail as below with referring to the accompanying drawings.

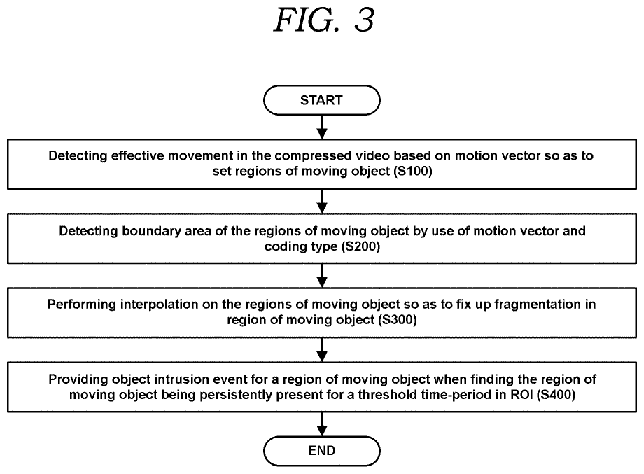

FIG. 3 is a flow chart illustrating an overall procedure of detecting object intrusion in compressed video according to the present invention. The method of detecting object intrusion according to the present invention may be preferably performed by a video analysis server of a system which handling a sequence of compressed video, e.g., CCTV video surveillance system.

In the present invention, the regions of moving object may be extracted from compressed video at high speed, without necessity of decoding compressed video, but by use of syntax information of each of image blocks, i.e., macro blocks and sub blocks, etc., preferably motion vector and coding type information which are obtained by parsing the bit-stream of the compressed video. The regions of moving object may fail to exactly reflect the border line of moving objects, which shall be confirmed in the figures attached hereto. However, the regions of moving object have advantages that they may be extracted at high speed and are highly reliable. Then, in the present invention, based on the regions of moving object which have been extracted above, it is identified whether object intrusion exists in the compressed video, i.e., whether someone is intruding or not.

Further, according to the present invention, regions of moving object may be extracted and object intrusion may be detected out of compressed video, which may be done without decoding the compressed video. However, the present invention shall not be constructed as limited to embodiments in which apparatus or software according to the present invention would not or must not decode the compressed video.

The concept of detecting object intrusion in compressed video according to the present invention will be described below with reference to FIG. 3.

Step (S100): First, effective movements to which substantial meaning may be given are detected in the compressed video based on motion vector of the compressed video. Then, the image regions in which the effective movements are detected are set as regions of moving object.

For this purpose, motion vector and coding type is parsed for coding units of the compressed video according to video compression standard such as H.264 AVC or H.265 HEVC, etc. The size of the coding unit is usually more or less 64×64 pixel or 4×4 pixel, and may be flexibly configured.

For each of image blocks, motion vector is accumulated for a predetermined time-period (e.g., 500 msec), and then the motion vector accumulation is checked whether it is higher than a predetermined first threshold (e.g., 20). When an image block which passes the check is found, it is regarded that effective movement is found in the image block, and accordingly the image block is marked as region of moving object. By use of the check above, any motion vector whose accumulation value for a specific time-period fails to be higher than the first threshold shall be ignored under estimating that corresponding change in video is rather small.

Step (S200): Then, for the regions of moving object which have been detected in the aforesaid (S100), the extent of boundary area is detected by use of motion vector and coding type. For this purpose, each of a plurality of image blocks which are located adjacent around the image blocks which have been marked as region of moving object is investigated. When its motion vector is higher than a second threshold (e.g., 0) or when its coding type is Intra Picture, the corresponding image block is also marked as region of moving object. Effectively, through this procedure, the corresponding image block become to form a single lump with a region of moving object this is detected in the aforesaid (S100).

If an image block which having more or less movement is found around the regions of moving object which having effective movement, the image block may be also marked as region of moving object, with understanding that the image block is likely to be a single lump with one of the aforesaid regions of moving object. Further, because motion vector is unavailable for Intra Picture, it is impossible to perform checking by use of motion vector. In this regards, Intra Pictures which are located adjacent to image blocks which have already been detected as region of moving object may be estimated to form a single lump with the regions of moving object.

Step (S300): The interpolation is performed on the regions of moving object which have been detected in the aforesaid (S100) and (S200) so as to fix up fragmentation in region of moving object. In the previous procedure, regions of moving object have been checked in the unit of image block. Accordingly, although it is actually a single moving object (e.g., human), due to some unmarked image blocks being sparsely mixed between regions of moving object, the single moving object may be fragmented into a plurality of regions of moving object.

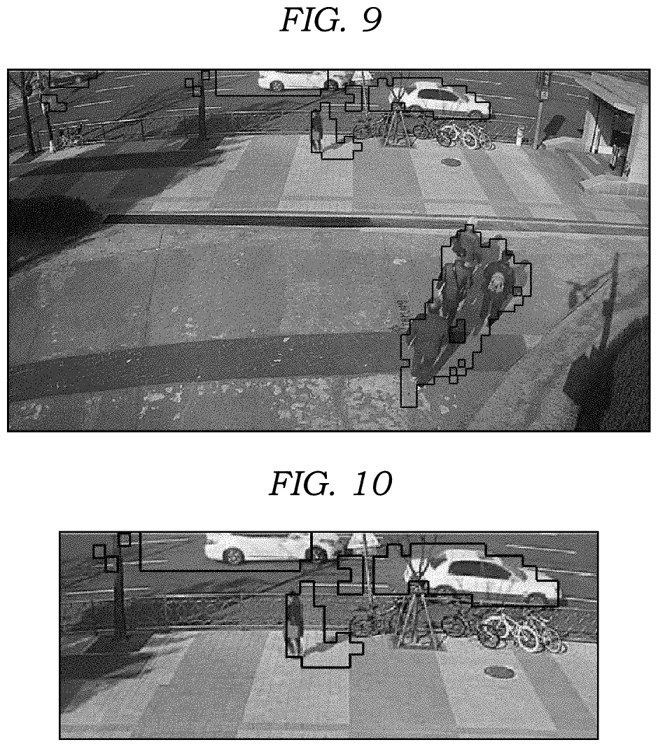

Therefore, if one or small number of unmarked image blocks are found with being surrounded by a plurality of marked image blocks, they are also marked as region of moving object. Through this procedure, the fragmented regions of moving object shall be put together into a single lump, whose effect may be clearly shown by comparing FIG. 9 and FIG. 12

Step (S400): Through the procedure above, regions of moving object have been promptly extracted out of the compressed video based on syntax information (motion vector, coding type) of coding unit. In (S400), by use of the extraction result of regions of moving object as above, someone's intrusion is detected in the compressed video for the purpose of crime prevention. This is referred to as ‘object intrusion’ in this specification. The video surveillance system informs monitoring agents of the fact that object intrusion has occurred and further of the location where the object intrusion has occurred, by which the monitoring agents may pay more attention so as to enhance the crime prevention effect. Further, information on the object intrusion may be useful in view of the proof of criminal evidence.

In the present invention, object intrusion event are provided for a region of moving object when the region of moving object is found being present persistently enough in a predetermined ROI (region-of-interest). That is, when a region of moving object persistently stays in a predetermined ROI of the compressed video for a predetermined time-threshold, object intrusion event is generated with respect to the region of moving object.

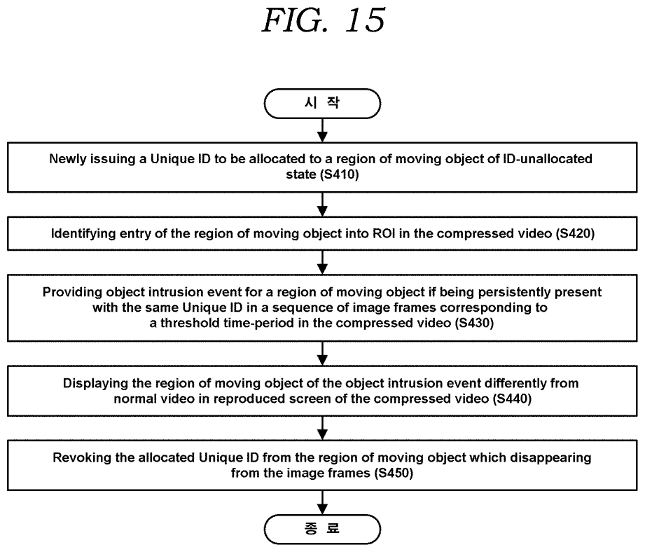

There shall be described below with referring to FIG. 15 more detailed procedure of detecting object intrusion in compressed video.

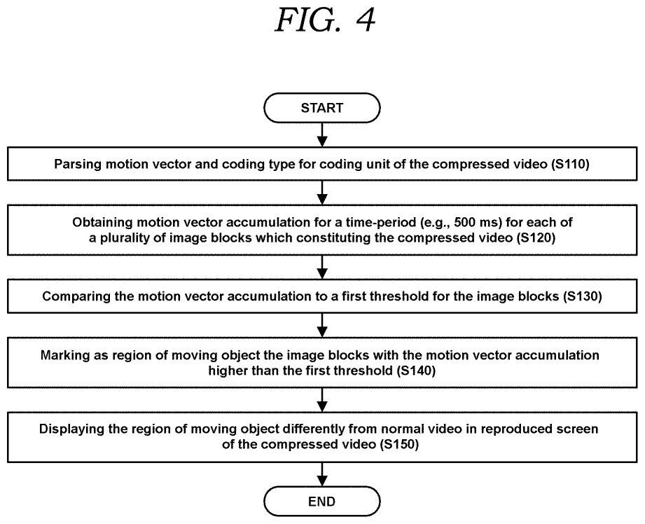

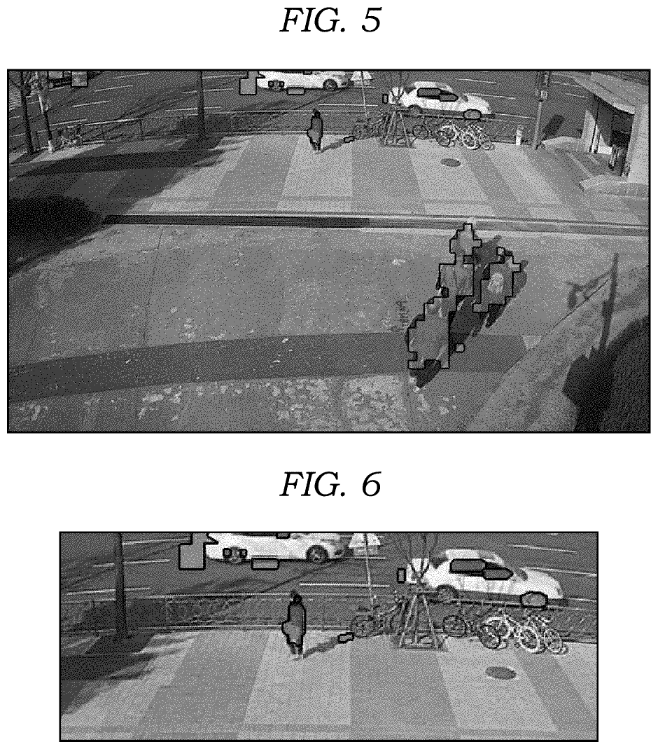

FIG. 4 is a flow chart illustrating an embodiment of the procedure of detecting effective movement in compressed video in the present invention. FIG. 5 is a view illustrating an example of the result of performing the procedure of detecting region of effective movement on a CCTV monitoring screen according to the present invention.

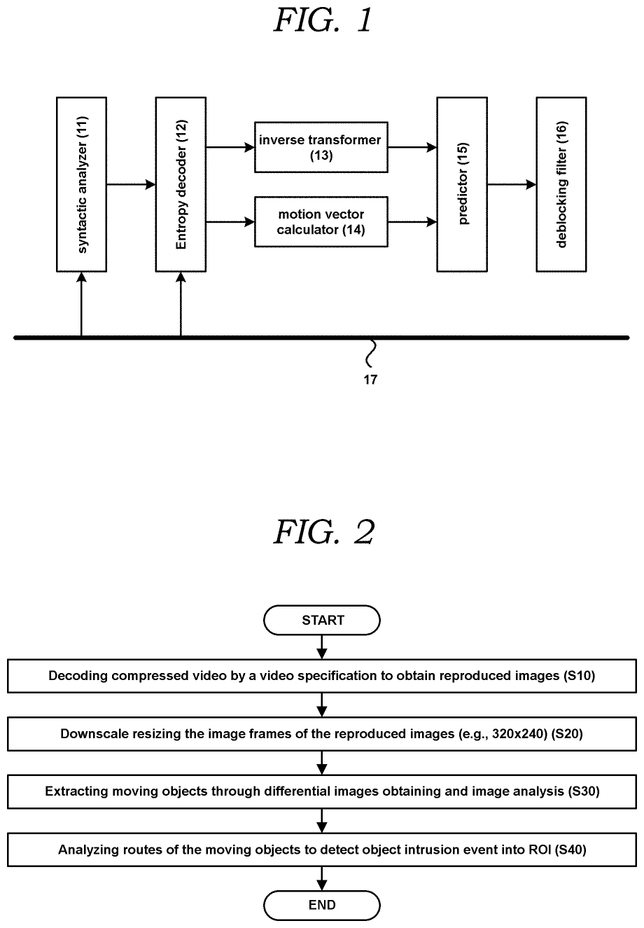

Step (S110): First, coding units of the compressed video are parsed so as to obtain motion vector and coding type. Referring to FIG. 1, the video decoding apparatus performs syntactic analysis (header parsing) and motion vector calculation for bit-stream of the compressed video by a video compression standard such as H.264 AVC or H.265 HEVC, etc. By this procedure, motion vector and coding type is parsed for coding units of the compressed video.

Step (S120): The motion vector accumulation for a predetermined time-period (e.g., 500 ms) is obtained for each of a plurality of image blocks which constituting the compressed video. This step is proposed in order to detect any substantially meaningful movement, i.e., effective movement, in the compressed video, e.g., cars in driving, running peoples, and crowds fighting each other. The objects of substantially meaningless movement may not be detected, e.g., shaking leaves, temporal ghosts, and shadows that change slightly by the reflection of light.

For this purpose, motion vector accumulation is obtained by accumulating motion vectors of the unit of one or more image blocks for a predetermined time-period (e.g., 500 msec). The term of ‘image blocks’ may include macro blocks and sub blocks in this specification.

Steps (S130, S140): For the plurality of image blocks, the motion vector accumulation is compared with a predetermined first threshold (e.g., 20). Then, image blocks with the motion vector accumulation higher than the first threshold are marked as region of moving object.

When an image block having motion vector accumulation higher than a specific number is found, the image block is marked as region of moving object with regarding that some substantially meaningful movement, i.e., effective movement, has been found in that image block. For example, any movement to which monitoring agents of video surveillance system worth paying attention, e.g., a person who is running, may be selectively detected. On the other hand, if any motion vector whose accumulation value for a specific time-period fails to be higher than the first threshold shall be ignored in detecting procedure under estimating that change in video is rather small.

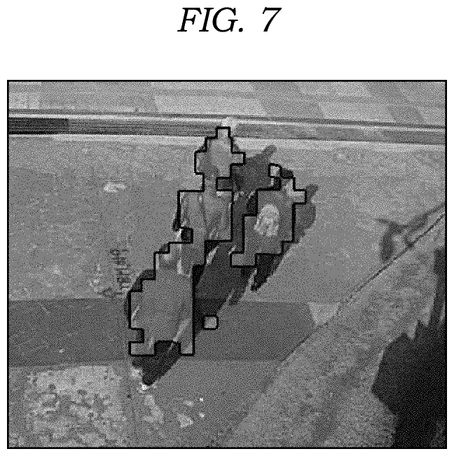

Step (S150): The region of moving object is displayed differently from normal video in reproduced screen of the compressed video. FIG. 5 is a view illustrating an example of the result of performing the procedure of detecting region of effective movement on a CCTV monitoring screen according to the present invention. In the FIG. 5, a plurality of image blocks with the motion vector accumulation higher than the first threshold are marked as region of moving object, and are displayed as bold-line boxes on monitor screen. FIGS. 6 and 7 are partial enlargement views of important parts in FIG. 5.

Referring to FIGS. 5 to 7, sidewalk blocks, roads, and shade parts are not marked as region of moving object, whereas walking peoples or cars in driving are marked as region of moving object. In this specification, the regions of moving object are represented with bold-line block. However, in CCTV monitor screen, the regions of moving object may be preferably represented by a color by which monitoring agents may immediately identify the region of moving object.

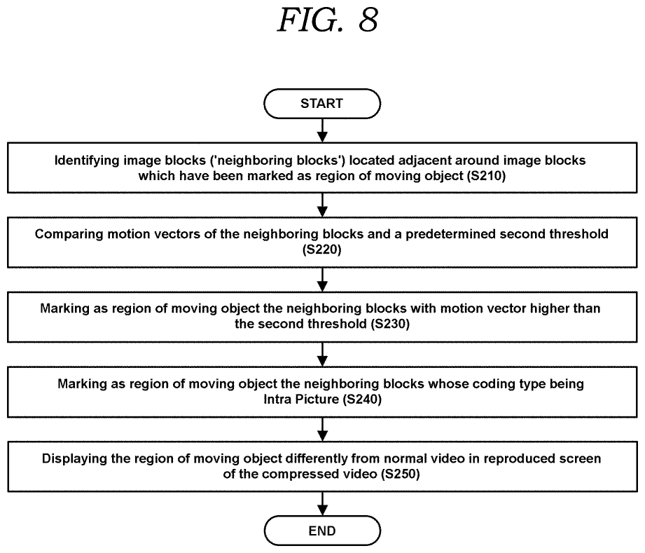

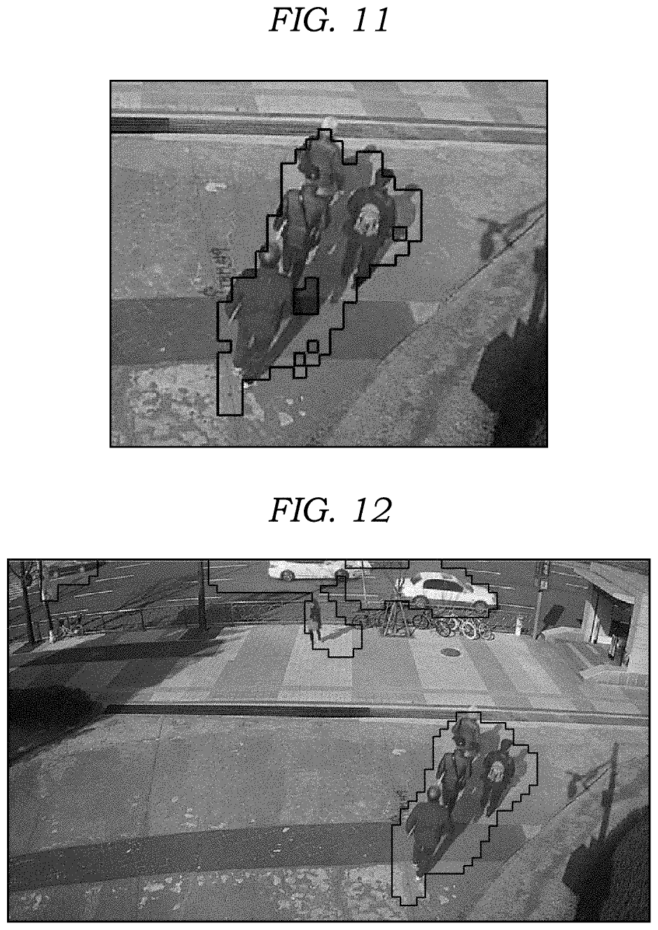

FIG. 8 is a flow chart illustrating an embodiment of the procedure of detecting boundary area of region of moving object in the present invention. FIG. 9 is a view illustrating an example of the result of performing the procedure of detecting boundary area of region of moving object according to the present invention. FIGS. 10 and 11 are partial enlargement views of important parts in FIG. 9.

Referring to FIGS. 5 to 7, it may be found that moving objects have been inappropriately marked, that is, only a part of moving objects are marked. When examining walking peoples or cars in driving, it may be identified that not all of those objects but only some of their blocks are marked. Further, it is also found that more than one regions of moving object have been marked for only one moving object. That means that the criteria in (S100) of marking region of moving object is very useful in filtering out normal regions, but also is too strict.

Therefore, it is necessary to investigate the surroundings of regions of moving object so as to detect the boundary of moving objects.

Step (S210): First, it is identified a plurality of image blocks which are located adjacent around the image blocks which have been marked as region of moving object in the aforesaid (S100). For convenience, they are referred to as ‘neighboring blocks’ in this specification. These neighboring blocks are included in a part which has not been marked as region of moving object in (S100). In the procedure of FIG. 8, the neighboring blocks are further investigated in order to try to find any of the neighboring blocks may be included in the boundary of the regions of moving object.

Steps (S220, S230): The values of motion vectors of the plurality of neighboring blocks are compared with a predetermined second threshold (e.g., 0). Then, some of the neighboring blocks which having motion vector higher than the second threshold shall be marked as region of moving object. If some image blocks are located adjacent to a region of moving object of which substantially effective movement being confirmed and more or less movement is found in the image blocks, when considering the characteristics of shooting video, the image blocks are likely to be a single lump with the region of moving object. Therefore, these neighboring blocks are also marked as region of moving object.

Step (S240): Further, some of the plurality of neighboring blocks whose coding type is Intra Picture shall be marked as region of moving object. The motion vector is unavailable for Intra Picture, which render it impossible to check based on motion vector whether any movement is present or not in the neighboring blocks of Intra Picture. In this case, it is safer to let the configuration of region of moving object of the image blocks which have already been detected as region of moving object into their adjacent Intra Picture.

Step (S250): The region of moving object is displayed differently from normal video in reproduced screen of the compressed video. FIG. 9 is a view illustrating an example of the result of performing the procedure of detecting boundary area in the present invention, wherein a plurality of image blocks which have been marked as region of moving object in the procedure above are displayed as bold-line boxes on monitor screen. Referring to FIGS. 10 and 11, it is discovered that the regions of moving object of FIGS. 10 and 11 are extended further around the box-marked regions of moving object of FIGS. 6 and 7, by which the regions of moving object are about to completely cover moving objects.

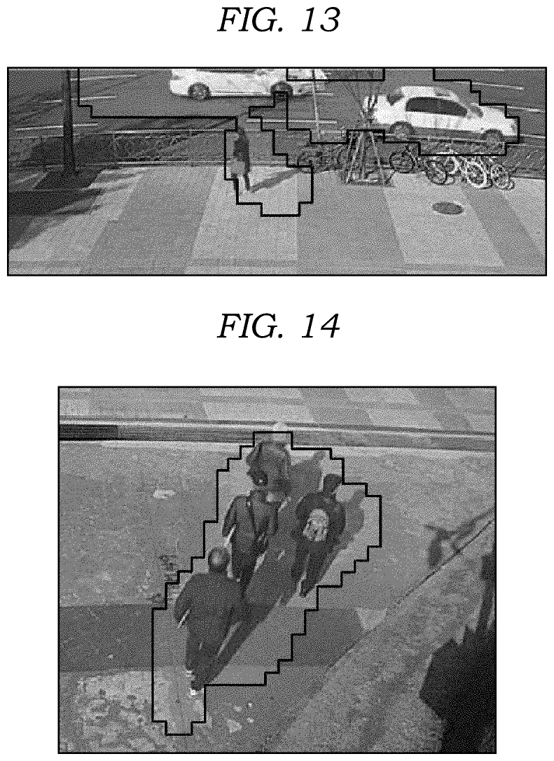

FIG. 12 is a view illustrating an example of the result of performing interpolation so as to make up regions of moving object in the present invention. FIGS. 13 and 14 are partial enlargement views of important parts in FIG. 12.

Step (S300) is a procedure of performing interpolation to the regions of moving object which are marked in the aforesaid (S100) and (S200) so as to fix up fragmentation of region of moving object. Referring to FIGS. 9 to 11, unmarked image blocks are found in the space between box-displayed regions of moving object. When unmarked image blocks are sparsely mixed like this, it is difficult to determine whether these are separate moving objects or these shall be regarded a single lump. In special, these unmarked image blocks become to form a mottled display on monitor screen of CCTV video surveillance system, which renders monitoring agents unable to promptly figure out the CCTV video. Further, if region of moving object is fragmented, the result of (S400) may become inaccurate. Further, if regions of moving object are fragmented, the number of regions of moving object becomes increased, which renders the process of (S400) to become complicated.

Accordingly, in the present invention, if one or small number of unmarked image blocks are found with being surrounded by a plurality of image blocks which are marked as region of moving object, they are also marked as region of moving object, which is referred as ‘interpolation’. By comparing FIG. 9 and FIG. 12, the unmarked image blocks between regions of moving object are marked as region of moving object. By the interpolation, the detection result of moving objects may become more intuitive and accurate for the reference purpose of monitoring agents.

FIG. 15 is a flow chart illustrating an embodiment of the procedure of detecting object intrusion event based on persistency of existence of the region of moving object in region-of-interest in the present invention.

As described above, the present invention extracts regions of moving object by use of syntax information which may be easily obtained for coding unit of compressed video. The conventional procedures, e.g., decoding of compressed video, obtaining of differential video, and image analysis, are unnecessary, which may result in processing time improvement of maximum 20 times in inventor's test. However, this approach has the drawback of being less accurate. This approach does not extract moving objects themselves, but extract lumps of image blocks which are estimated to include moving objects, which is conceptual difference.

With reflecting the conceptual difference as above, the present invention has adopted different approach than prior art in determining someone's intrusion event from CCTV video. In the present invention, if lumps of images blocks which are estimated to include moving objects, i.e. region of moving object, are found in a predetermined ROI for a long time-period, an object intrusion event is provided to the region of moving object, under considering that the possibility of intrusion is rather high in comparison with ordinary situations of the ROI, although the subject in the region of moving object has not been clearly identified.

There shall be described in detail an embodiment of the procedure of detecting object intrusion which is adopted in the present invention.

Step (S410): First, in order to handle the region of moving object as an object, if a region of moving object is found as ID (identification information) unallocated state, a Unique ID is newly issued and allocated to the region of moving object of ID-unallocated state. This means that a lump of image blocks which are combined there-between and have been marked as region of moving object in the previous procedures may be handled as an object. In order to implement the handling in software processing, Unique ID's are allocated and managed with regard to the regions of moving object (i.e., lumps of image blocks).

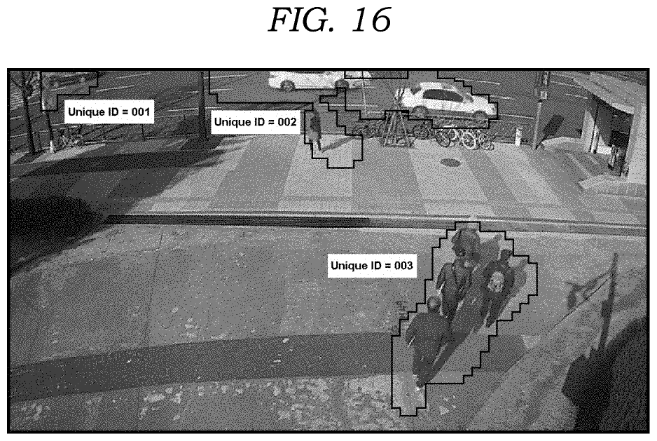

Accordingly, it is preferable that the steps of FIG. 15 following (S410) are processed with referring to the Unique ID's which are allocated to regions of moving object. FIG. 16 shows an example of allocating Unique ID's to regions of moving objects in the present invention.

In (S410), lumps of adjacent image blocks which are marked as region of moving object should be identified whether they are the same or not among a sequence of image frames, which enables a region of moving object being currently handled to be identified whether Unique ID was previously issued or not.

In the present invention, it is not interested in the contents of original video images. Alternatively, it is checked whether image blocks are region of moving object or not. Therefore, it is impossible to accurately check the identity of lumps of region of moving object between consecutive image frames. That is, because the contents in video is not identified, for example, when a cat is replaced by a dog at the same portion between consecutive image frames, the change may not be recognized. However, considering that time intervals between frames are very short and further that subjects of video surveillance system usually move at normal speed, the likelihood of such happening is very low.

Therefore, in the present invention, the lumps of region of moving object are estimated to represent the same region of moving object if they have more overlapped image blocks than a threshold ratio or a threshold number between consecutive image frames. According to this approach, although the contents of original video images is still unknown, the corresponding situation may be determined, that is, whether a specific region of moving object is moving, whether a new region of moving object has appeared, or whether a previous region of moving object has disappeared. This approach shows lower accuracy of determination than conventional arts, but has advantages in actual applications because it shows tremendous enhancement in data processing speed.

Steps (S420, S430): In case of CCTV video surveillance, the procedure of suspecting an object intrusion when finding someone's presence for a long time may not be necessary for all locations of a district. Rather, it is general that the procedure of suspecting an object intrusion is selectively performed for some locations in which such situation does not happen in normal state for all time or for a specific time band (e.g., from midnight to 6 a.m.). These locations are referred to as ‘Region-Of-Interest (ROI)’, which are preset in video surveillance system.

When an entry of a region of moving object into region-of-interest (ROI) in the compressed video is identified, it is checked whether the region of moving object is a substantial object or not and whether the region of moving object stays in the ROI for more than a predetermined time-period or the region of moving object passes by the ROI for a moment.

In this procedure, in order to make assure the checking above is performed with respect to the same object, the process is performed with respect to the same Unique ID of region of moving object.

That is, a sequence of image frames (e.g., 5 seconds×30 frame/sec=150 frames) in the compressed video which is corresponding to a predetermined time-threshold (e.g., 5 seconds) are investigated. If the region of moving object is persistently present, the region of moving object is estimated to be a substantial object which is doing something in the ROI, rather than regarding it as a temporal passing-by or a ghost due to noise problem in the data processing.

In this procedure, it does not mean that the region of moving object exists in all of the sequence of image frames. It may be sufficient that the region of moving object is generally found when the entire of the sequence of image frames. For example, it may be implemented to establish persistency of existence for a region of moving object, if the region of moving object is found in more than 75 percent of image frames (e.g., 150 frames*0.75=112.5 frames).

When the persistency of existence is established for a region of moving object in a specific ROI, the object intrusion event is provided with respect to the region of moving object. Although the system does not exactly know what the object in the region of moving object is or is doing, it may be determined that a substantial object is probably intrude the ROI.

Step (S440): The region of moving object where the object intrusion event has been provided is displayed differently from normal video in reproduced screen of the compressed video. Therefore, the monitoring agents of the video surveillance system may promptly identify points in the video where the object intrusion is detected, so that the monitoring agents may monitor the screen with higher attentiveness. This may further help the proof of criminal evidence.

Step (S450): Further, when the region of moving object disappears from the sequence of image frames, the Unique ID which has been allocated to region of moving object the in (S410) shall be revoked so as to delete the region of moving object.

Further, the present invention may also be embodied as computer readable codes on a non-transitory computer-readable medium. The non-transitory computer-readable medium is any data storage device that can store data which may be thereafter read by a computer system, which include hard disks, SSDs, CD-ROMs, NAS, magnetic tapes, web-disks, and cloud disks. The non-transitory computer-readable medium can also be distributed over network coupled computer systems so that the computer readable code is stored and executed in a distributed fashion.

1. A syntax-based method of detecting object intrusion in compressed video, the method comprising:
a first step of parsing bit-stream of the compressed video so as to obtain motion vector and coding type for coding unit;
a second step of obtaining motion vector accumulation for a predetermined first time-period for a plurality of image blocks which constituting the compressed video;
a third step of comparing the motion vector accumulation to a predetermined first threshold for the plurality of image blocks;
a fourth step of marking as region of moving object some of the image blocks which having the motion vector accumulation higher than the first threshold; and
a fifth step of providing object intrusion event for the region of moving object when finding the region of moving object being persistently present for a predetermined second time-period in a predetermined ROI (region-of-interest) in the compressed video.

2. The method according to claim 1, wherein the fifth step comprising:
a step 5a of newly issuing a Unique ID so as to allocate the Unique ID to the region of moving object which being of ID-unallocated state;
a step 5b of identifying entry of the region of moving object into a predetermined ROI in the compressed video;
a step 5c of providing object intrusion event for the region of moving object which being persistently present with the same Unique ID in a sequence of image frames corresponding to a predetermined second time-period in the compressed video; and
a step 5d of revoking the allocated Unique ID from the region of moving object which disappearing from the series of image frames.

3. The method according to claim 1, the method, between the fourth step and the fifth step, further comprising:
a step a of identifying a plurality of image blocks (hereinafter referred to as ‘neighboring blocks’) which being located adjacent around the region of moving object;
a step b of comparing motion vectors of the plurality of neighboring blocks which has been obtained in the first step and a predetermined second threshold; and
a step c of further marking as region of moving object some of the neighboring blocks which having motion vector higher than the second threshold by the comparing in the step b.

4. The method according to claim 3, the method, after the step c, further comprising:
a step d of further marking as region of moving object some of the neighboring blocks whose coding type being Intra Picture;

5. The method according to claim 4, the method, after the step d, further comprising:
a step e of performing interpolation to the plurality of regions of moving object so as to further mark as region of moving object unmarked image blocks which being surrounded by region of moving objects, wherein the number of unmarked image blocks is less than a predetermined number.

6. The method according to claim 1, wherein the image blocks comprises macro blocks and sub blocks.

7. A non-transitory computer-readable medium containing program code which executes the syntax-based method of detecting object intrusion in compressed video according to claim 1.

8. A non-transitory computer-readable medium containing program code which executes the syntax-based method of detecting object intrusion in compressed video according to claim 2.

9. A non-transitory computer-readable medium containing program code which executes the syntax-based method of detecting object intrusion in compressed video according to claim 3.

10. A non-transitory computer-readable medium containing program code which executes the syntax-based method of detecting object intrusion in compressed video according to claim 4.

11. A non-transitory computer-readable medium containing program code which executes the syntax-based method of detecting object intrusion in compressed video according to claim 5.

12. A non-transitory computer-readable medium containing program code which executes the syntax-based method of detecting object intrusion in compressed video according to claim 6.
